(19) United States
(12) Patent Application Publication
(10) Pub. No.: US 2016/0055970 A1
(43) Pub. Date: Feb. 25, 2016

(54) High Voltage Wire Leading Method for Stereoscopic Wound Core Open Ventilated Dry-Type Transformer

(71) Applicant: Haihong Electric Co., Ltd., Kaiping City (CN)

(72) Inventors: Kaixuan Xu, Kaiping City (CN); Xianqing Guo, Kaiping City (CN); Qingning Liang, Kaiping City (CN); Liqiong Long, Kaiping City (CN)

(21) Appl. No.: 14/526,990

(22) Filed: Oct. 29, 2014

(30) Foreign Application Priority Data
Aug. 22, 2014 (CN) 201410419491.3

(51) Int. Cl. H01F 41/10; H01F 41/06; H01F 41/02

(52) U.S. Cl. CPC H01F 41/10; H01F 41/0206; H01F 41/06

(57) ABSTRACT

The invention discloses a high voltage wire leading method for a stereoscopic wound core open ventilated dry-type transformer, which comprises the steps of fixing stereoscopic wound cores arranged in a triangular shape between an upper clamp and a lower clamp, winding A, B and C three phase coils on the stereoscopic wound cores and arranging a high voltage wire leading bracket on the upper clamp, wherein the high voltage wire leading bracket is provided with connecting terminals which respectively correspond to the A, B and C three phase coils; and each phase coil is respectively provided with a wire inlet terminal and a wire outlet terminal. In the high voltage wire leading method, each of the three A, B, and C phase coils is provided with two wire outlet terminals and the numbers of turns of the three phase coils are still equal, so that under the condition of not changing the numbers of the turns of the coils, the added wire outlet terminals make leading more conveniently and the lead structure simpler.

### CROSS-REFERENCE TO RELATED APPLICATIONS

This Application claims priority to Application 201410419491.3 filed on Aug. 22, 2014 in China.

### BACKGROUND

The invention relates to a wire leading technology of a transformer coil, in particular to a high voltage wire leading method for a stereoscopic wound core open ventilated dry-type transformer.

High voltage leads of existing stereoscopic wound core open-type transformer need to be led to the side of clamp in order to bring convenience to user for wiring; however, three phases of coils are arranged in a triangular shape and outgoing lines are not on the same level, resulting in complex wire leading process, in which a necessary insulation distance between the leads may increase the integral outline size of the transformer, and resulting in numerous bending of the leads which are difficult to fix.

To solve the technical problems above, the invention provides a high voltage wire leading method for a stereoscopic wound core open ventilated dry-type transformer. The high voltage wire leading method enables corresponding wire outlet terminals to be led out of different surfaces of a high voltage coil and makes the lead structure simpler, aesthetical and easy to connect.

To fulfill the objectives, the invention adopts the following technical scheme:

The high voltage wire leading method for the stereoscopic wound core open ventilated dry-type transformer comprises the steps of fixing stereoscopic wound cores arranged in a triangular shape between an upper clamp and a lower clamp, winding A, B and C three phase coils around the stereoscopic wound cores and arranging a high voltage wire leading bracket on the upper clamp, wherein the high voltage wire leading bracket is provided with connecting terminals which respectively correspond to the A, B and C three phase coils; each phase coil is respectively provided with a wire inlet terminal and a wire outlet terminal, characterized in that:

After the winding of the A phase coil is completed, the wire outlet terminal of the A phase coil is connected to the A phase connecting terminal; an outgoing line is led out of the A phase wire outlet terminal and is wound by an angle to form an A phase second wire outlet terminal and the A phase second wire outlet terminal is close to the C phase wire inlet terminal and is connected to the C phase wire inlet terminal;

After the winding of the B phase coil is completed, the wire outlet terminal of the B phase coil is connected to the B phase connecting terminal; an outgoing line is led out of the B phase wire outlet terminal and is wound by an angle to form a B phase second wire outlet terminal and the B phase second wire outlet terminal is close to the A phase wire inlet terminal and is connected to the A phase wire inlet terminal; and

After the winding of the C phase coil is completed, the wire outlet terminal of the C phase coil is connected to the C phase connecting terminal; an outgoing line is led out of the C phase wire outlet terminal and is wound by an angle to form a C phase second wire outlet terminal and the C phase second wire outlet terminal is close to the B phase wire inlet terminal and is connected to the B phase wire inlet terminal;

By adopting the high voltage wire leading method, two wire outlet terminals are led out of each of the A, B and C three phase coils, and the numbers of turns of the three phase coils are still equal, so that under the condition of not changing the numbers of the turns of the coils, the added wire outlet terminals make leading more conveniently, the wire leading more easily and the lead structure simpler.

Preferably, the second outgoing line led out of the A phase wire outlet terminal is wound more by an angle of 145 degrees to 155 degrees.

Preferably, the second outgoing line led out of the B phase wire outlet terminal is wound more by an angle of 55 degrees to 65 degrees.

Preferably, the second outgoing line led out of the C phase wire outlet terminal is wound more by the angle of 5 degrees to 15 degrees.

The invention has the beneficial effects that by adopting the high voltage wire leading method, the wire outlet terminals of the stereoscopic wound core coils which are of a triangular structure can be ingeniously arranged to be connected to the wire outlet terminals, so connecting distances between the leads in the three phase coils are shortened, arrangement of the leads is simplified, materials are reduced, each leads are in a simple structure and the problem of complexity of wire leading of the stereoscopic wound core open-type transformer is solved.

### BRIEF DESCRIPTION OF DRAWINGS

The embodiments of the invention are further described by combining the accompanying drawings.

FIG. 1 is a structural diagram of three phase coils of the invention;

FIG. 2 is a schematic diagram of connection in the invention.

### DETAILED DESCRIPTION

A high voltage wire leading method for a stereoscopic wound core open ventilated dry-type transformer, which is provided by the invention, comprises the steps: firstly, fixing stereoscopic wound cores arranged in a triangular shape between an upper clamp and a lower clamp, then, winding A, B and C three phase coils around the stereoscopic wound cores and arranging a high voltage wire leading bracket on the upper clamp, wherein the high voltage wire leading bracket is provided with connecting terminals which respectively correspond to the A, B and C three phase coils. The connecting terminals respectively are an A phase connecting terminal, a B phase connecting terminal and a C phase connecting terminal. And each phase coil is respectively provided with a wire inlet terminal and a wire outlet terminal.

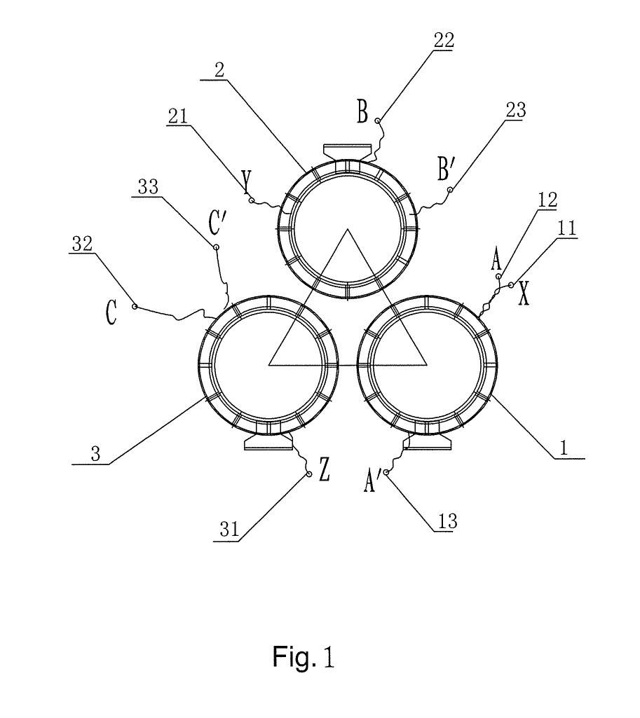

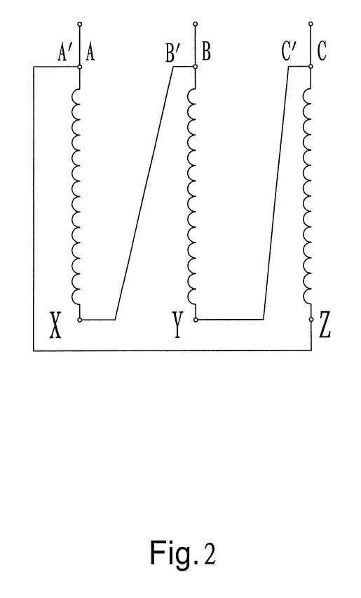

With reference to FIG. 1 and FIG. 2, in the embodiment, the positions of X, A and At in the accompanying drawings respectively represent the A phase wire inlet terminal 11, the A phase wire outlet terminal 12 and the A phase second wire outlet terminal 13 which correspond to the A phase coil 1; the positions of Y, B and B′ in the accompanying drawings respectively represent the B phase wire inlet terminal 21, the B phase wire outlet terminal 22 and the B phase second wire outlet terminal 23 which correspond to the B phase coil 2. The positions of Z, C and C′ in the accompanying drawings respectively represent the C phase wire inlet terminal 31, the C phase wire outlet terminal 32 and the C phase second wire outlet terminal 33 which correspond to the C phase coil 3; after the winding of the A phase coil 1 is completed, the wire outlet terminal 12 of the A phase coil 1 is connected to the A phase connecting terminal, another outgoing line is led out of the A phase wire outlet terminal 12 and is wound by an angle of 150 degrees to form the A phase second wire outlet terminal 13, i.e. the position of A′, and the A phase second wire outlet terminal 13 is close to the C phase wire inlet terminal 31 and is connected to the C phase wire inlet terminal 31; after the winding of the B phase coil 2 is completed, the wire outlet terminal 22 of the B phase coil 2 is connected to the B phase connecting terminal, an outgoing line is led out of the B phase wire outlet terminal 22 and is wound more by an angle of 60 degrees to form the B phase second wire outlet terminal 23, i.e. the position of B′, and the B phase second wire outlet terminal 23 is close to the A phase wire inlet terminal 12 and is connected to the A phase wire inlet terminal 12; after the winding of the C phase coil 3 is completed, the wire outlet terminal 32 of the C phase coil 3 is connected to the C phase connecting terminal, an outgoing line is led out of the C phase wire outlet terminal 32 and is wound more by an angle of 10 degrees to form the C phase second wire outlet terminal 33, i.e. the position of C′, the C phase second wire outlet terminal is close to the B phase wire inlet terminal 21 and is connected to the B phase wire inlet terminal 21. The lead structure is formed by connecting A′ to Z, connecting B′ to X and connecting C′ to Y, so the arrangement of leads is simplified, and the schematic diagram of connection is shown in FIG. 2.

By adopting the high voltage wire leading method, two wire outlet terminals are led out of each of the A, B and C three phase coils and the numbers of turns of the three phase coils are still equal, so that under the condition of not changing the numbers of the turns of the coils, the added wire outlet terminals make the wire leading more conveniently and the lead structure simpler.

The above is only the preferred embodiments of the invention. The invention is not limited to the structure of the embodiments and any conditions for implementing the technical effects of the invention by the same means shall belong to the scope of protection of the invention.

What is claimed is:

1. A high voltage wire leading method for a stereoscopic wound core open ventilated dry-type transformer, comprising the steps of fixing stereoscopic wound cores arranged in a triangular shape between an upper clamp and a lower clamp, winding A, B and C three phase coils around the stereoscopic wound cores and arranging a high voltage wire leading bracket on the upper clamp, wherein the high voltage wire leading bracket is provided with connecting terminals which respectively correspond to the A, B and C three phase coils; each phase coil is respectively provided with a wire inlet terminal and a wire outlet terminal, characterized in that:
after the winding of the A phase coil is completed, the wire outlet terminal of the A phase coil is connected to the A phase connecting terminal; an outgoing line is led out of the A phase wire outlet terminal and is wound by an angle to form an A phase second wire outlet terminal and the A phase second wire outlet terminal is close to the C phase wire inlet terminal and is connected to the C phase wire inlet terminal;
after the winding of the B phase coil is completed, the wire outlet terminal of the B phase coil is connected to the B phase connecting terminal; an outgoing line is led out of the B phase wire outlet terminal and is wound by an angle to form a B phase second wire outlet terminal and the B phase second wire outlet terminal is close to the A phase wire inlet terminal and is connected to the A phase wire inlet terminal; and
after the winding of the C phase coil is completed, the wire outlet terminal of the C phase coil is connected to the C phase connecting terminal; an outgoing line is led out of the C phase wire outlet terminal and is wound more by an angle to form a C phase second wire outlet terminal and the C phase second wire outlet terminal is close to the B phase wire inlet terminal and is connected to the B phase wire inlet terminal.

2. The high voltage wire leading method for a stereoscopic wound core open ventilated dry-type transformer according to claim 1, characterized in that the second outgoing line led out of the A phase wire outlet terminal is wound by an angle of 145 degrees to 155 degrees.

3. The high voltage wire leading method for a stereoscopic wound core open ventilated dry-type transformer according to claim 2, characterized in that the second outgoing line led out of the B phase wire outlet terminal is wound more by an angle of 55 degrees to 65 degrees.

4. The high voltage wire leading method for a stereoscopic wound core open ventilated dry-type transformer according to claim 3, characterized in that the second outgoing line led out of the C phase wire outlet terminal is wound more by an angle of 5 degrees to 15 degrees.
